(19) United States
(12) Patent Application Publication
(10) Pub. No.: US 2014/0059411 A1
(43) Pub. Date: Feb. 27, 2014

(54) NOVEL COMPUTING SYSTEM

(71) Applicants: Zvi Or-Bach, San Jose, CA (US); Ze'ev Wurman, Palo Alto, CA (US); Brian Cronquist, San Jose, CA (US)

(72) Inventors: Zvi Or-Bach, San Jose, CA (US); Ze'ev Wurman, Palo Alto, CA (US); Brian Cronquist, San Jose, CA (US)

(73) Assignee: MONOLITHIC 3D INC., San Jose, CA (US)

(21) Appl. No.: 13/593,895

(22) Filed: Aug. 24, 2012

(51) Int. Cl. G06F 17/21

(52) U.S. Cl. CPC G06F 17/211
USPC 715/201

(57) ABSTRACT

A computing system including a processor, display, pointing device and memory; wherein the memory includes a text file, a graphics file corresponding to said text file and executable instructions to perform at least these actions (i) identify a selection of an alphanumeric identifier within a displayed text file, and then (ii) identify the appearance of the identifier in a corresponding graphics file, and then (iii) display a page of the graphics file comprising the appearance of the identifier.

### BACKGROUND OF THE INVENTION

1. Field of the Invention

This application relates to the general field of computing systems and intellectual property protection.

2. Discussion of Background Art

Intellectual Property protection, achieved through defensive disclosures and patent disclosures, becomes more important as time passes. Patents provide a period of exclusivity to the inventor in return for disclosing the detailed description of the invention. Defensive disclosure, on the other hand, prohibits others from patenting the invention and establishes it as a prior art available to all.

Each type of intellectual property disclosure requires a clear enabling description of the invention, consisting of text specification and drawings, the text being cross-referenced to the drawings through reference characters (REFC) that may function as unique identifiers. (In this application the terms REFC and “identifier” may be used interchangeably.) The REFC may be alphanumeric. Rules and convention dictate that every feature mentioned in the specification should use a REFC to a feature in the drawings, and every REFC present in the drawings must have text in the specification that describes it. REFC can also refer to a figure number that describes a complete drawing rather than to its feature. Further, the specification and the drawings must conform to other rules published from time to time by regulatory bodies.

The process of creating the enabling description may be tedious and frequently may involve multiple iterations, consuming significant time of the inventor and frequently also of trained legal professionals. The process of reviewing the specification and the drawings for clarity, consistency, and conformance to published rules typically consists of a tedious reading through of the specification while simultaneously scrolling through the corresponding drawings and inspecting the clarity and appropriateness of the relevant REFCs. In many cases, because of the complexity of the invention or the length of its specification and the number of drawings, such inspection gets lengthy, tedious, and error prone.

### SUMMARY

In one aspect, the invention describes a disclosure capture system that may use voice-to-text software to capture the verbal description and may use a graphical pointing device to link among drawing elements and the text of the specification.

In another aspect, the invention describes a disclosure capture system that may use a video capture system that can record the inventor giving a frontal presentation of the invention using a graphic projection system. The audio of the recording may be subsequently translated to text, and the salient gestures of the presenter over the graphics may be extracted from the video and analyzed, providing links among the drawing elements and the text of the specification.

In yet another aspect of the invention, the linked specification and drawings may be synchronized and simultaneously presented to a reviewer. As the reviewer scrolls through the specification, the corresponding drawings may be displayed and controlled to remain synchronized and allow for rapid and convenient review and editing of the disclosure.

In yet another aspect, a computing system including: a processor, display, pointing device and memory; wherein the memory comprises a text file, a graphics file corresponding to said text file and executable instructions to perform: (i) identify a selection of an alphanumeric identifier within a displayed text file, and then (ii) identify the appearance of said identifier in a corresponding graphics file, and then (iii) display a page of said graphics file comprising said appearance of said identifier.

In yet another aspect, a computing system including: a processor, display, pointing device and memory; wherein the memory comprises a text file, a graphics file corresponding to said text file and executable instructions to perform: (i) identify a selection of an identifier within a displayed graphics file, and then (ii) identify appearance of said identifier in a corresponding text file, and then (iii) display the page of said appearance of said identifier.

In yet another aspect, a computing system comprising: a processor, display, pointing device and memory; wherein said memory comprises executable instructions to perform: (i) identify a selection of a point within a displayed graphic file, and then (ii) create an identifier to identify said point and then (iii) add said identifier to said graphic file with a pointer pointing to said point.

### BRIEF DESCRIPTION OF THE DRAWINGS

Various embodiments of the invention will be understood and appreciated more fully from the following detailed description, taken in conjunction with the drawings in which:

FIG. 1 is an exemplary drawing illustration of a typical computer system;

FIG. 1A is an exemplary drawing illustration of two main windows simultaneously displayed to a user on a computer display;

FIG. 2 is an exemplary drawing illustration of an exemplary logic flow behind the synchronization of the drawings to the text; and

FIG. 3 is an exemplary drawing illustration of an exemplary logic flow behind the ‘reverse’ synchronization of the text to the drawings.

### DETAILED DESCRIPTION

Embodiments of the invention are described herein with reference to the drawing figures. Persons of ordinary skill in the art will appreciate that the description and figures illustrate rather than limit the invention and that in general the figures are not drawn to scale for clarity of presentation. Such skilled persons will also realize that many more embodiments are possible by applying the inventive principles contained herein and that such embodiments fall within the scope of the invention which is not to be limited except by the appended claims.

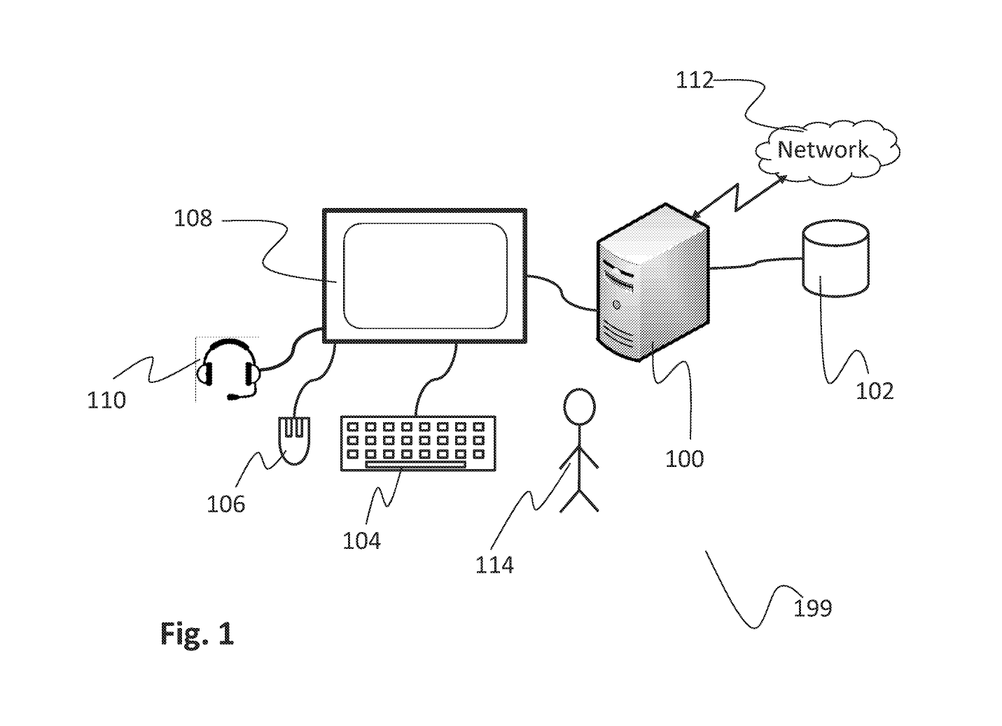

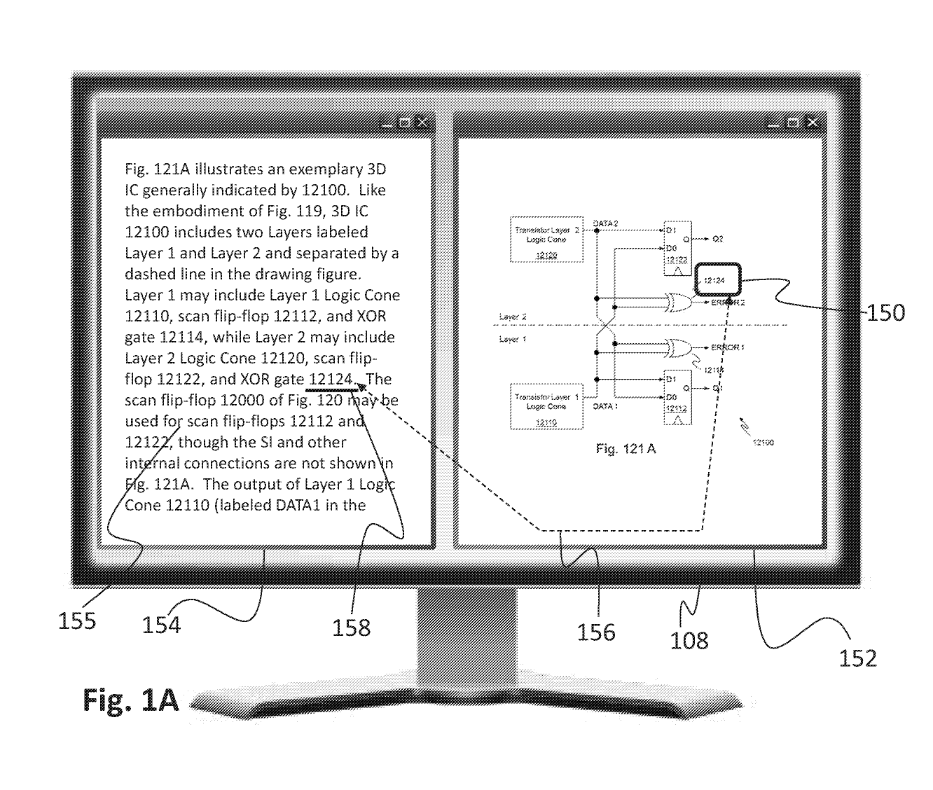

FIG. 1 is a drawing illustration of a typical computer system 199 which may be used in this invention. Computer system 199 may include elements such as, for example, a computer 100, a storage device 102, a keyboard 104, a pointing device 106, a computer display 108, a headset with microphone 110 and a network connection 112. Computer system 199 may include a USB drive reader to read the software off a USB drive, or may read the software off storage device 102 or the internet through network connection 112. The software may include executable instructions that computer 100 may execute. The executable instructions may reside in storage device 102, in an internet server accessible via the network connection 112, or in another memory device, for example, a USB stick. Storage device 102 may be a solid state drive or hard drive that may be part of the computer 100 or computer system 199. Pointing device 106 may include, for example, a wired mouse (shown), wireless mouse, or wireless laser pen. Computer 100 may include a processor, such as, for example, a micro-processor. Some or all of the elements of computer system 199 can be integrated within a single enclosure for the convenience of the user 114.

In an embodiment of the invention, a user, such as user 114, may verbally describe the invention to a speech-to-text (or voice to text) transcription system, such as, for example, Dragon Naturally Speaking of Nuance Communications, Inc., which translates the user's verbal description to text. Simultaneously with describing the invention, the user may utilize display software, such as, for example, PowerPoint from Microsoft, Inc., to display the prepared drawings. Furthermore, the user may use a pointing device, such as, for example, a mouse or a finger or similar object on a touch-sensitive surface, to indicate the particular elements of the drawings that are being described. Specialized software, which may include executable instructions, may capture the location of the drawing element being referenced and may insert linking tags (LT), which may be software artifacts associating locations of REFCs (In this application the terms REFC and “identifier” may be used interchangeably, and may be alphanumeric in character.) within text and graphic files, into the transcribed speech stream to link portions of the text with its corresponding drawing elements.

In another embodiment of the invention, the user, such as user 114, may describe the invention with the aid of drawings as if (or truly) in a public presentation and the description may be captured on a video recording. The video recording may be reprocessed using voice-to-text transcription software for the audio portion, and the simultaneous user gestures may be extracted as the user refers to drawing elements in his/her presentation. The extraction of graphic locations can be based, for example, on the user's manual gestures, and may be assisted by the use of pointing and/or tracking devices attached to user's hands or fingers, or may be assisted by a specialized projection surface, such as, for example, the SMART Board® from SMART Technologies. However extracted, the identified drawing elements locations may be inserted as LTs associating REFCs in the transcribed specification text stream with the corresponding drawing elements.

FIG. 1A is a drawing illustration of another aspect of the invention. The disclosure text stream 155 with embedded LT 156 may reside in memory and may be displayed for review and editing. Similarly, the associated drawings may reside in main memory and may be displayed for review and editing. The two main windows, text window 154 and graphics window 152, may be simultaneously displayed to the user on computer display 108 in a synchronized manner. Text window 154 may display a portion of a text file; the text file may be a patent specification file or a patent draft specification file. Graphics window 152 may display a portion of a corresponding graphics file; the graphics file may be the drawings portion of related patent file or a patent draft file being displayed in text window 154. The graphics file may include drawing numbers and figures.

Specification text may be displayed in the text window 154 with REFC 158 linked through LT 156 to corresponding REFC 150 in the drawing image rendered in the graphics window 152. When the user selects REFC 158 in the text window 154, the graphics window 152 may display the corresponding drawing with the associated REFC 150 highlighted. Conversely, the user can select an REFC 150 in the graphics window 152 and the text window 154 may focus on the text area that includes the corresponding and highlighted REFC 158. At this point the supporting software may offer a variety of utility functions, such as, for example, removing the LT with its associated REFC, re-link the LT to another drawing element or REFC on the drawing, and/or assign a unique or non-unique REFC to the LT that may be inserted in the specification text and the drawing. As the review process progresses and the user selects subsequent LTs, the text window 154 and graphics window 152 may be refreshed accordingly and may keep the two windows synchronized. The user may make selections with the pointing device 106 described hereinabove.

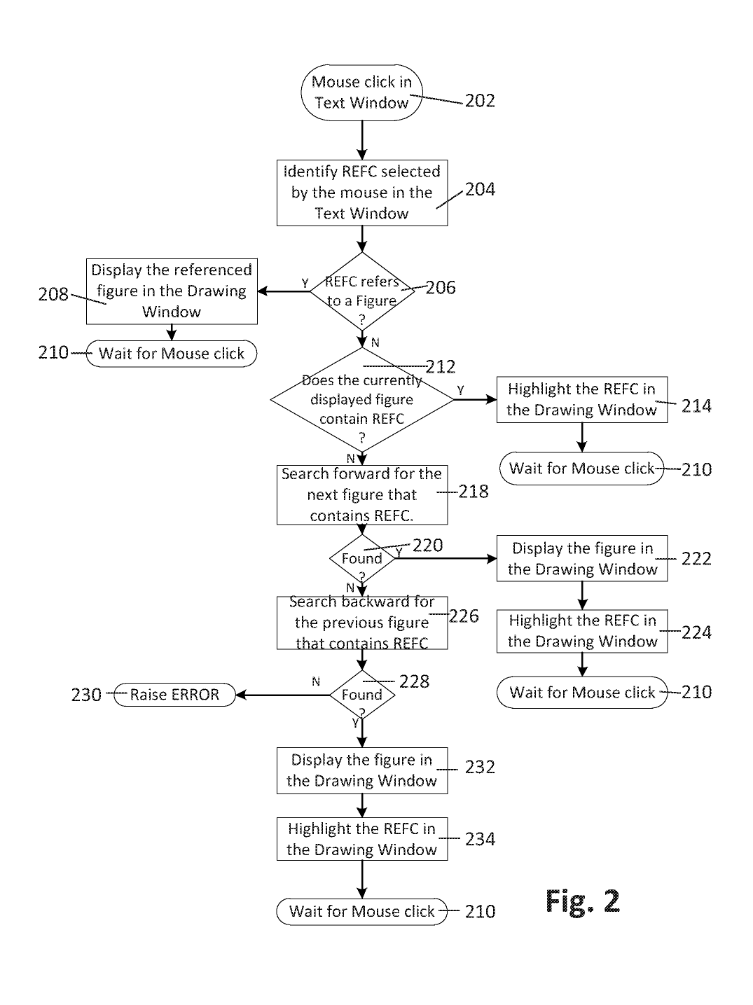

FIG. 2 is a drawing illustration of a flowchart illustrating an exemplary logic flow behind such synchronization of the drawings to the text. The system may wait for a mouse click on the embedded LT in the text window. Once the mouse click 202 arrives, the system may identify the REFC associated with the LT 204. A decision 206 may be made whether that REFC refers to a figure, or to an element thereof. In the case the REFC is a figure, that figure may be displayed 208 in the drawing window and the system may return to waiting on a mouse click 210. If the REFC refers to an element of a figure, the system checks 212 if that REFC is present in the currently displayed figure in the drawing window. If yes, that REFC may be highlighted 214 in the drawing window and the system returns to waiting on a mouse click 210. If the REFC is not present in the currently displayed figure, the system first searches to the REFC from the current figure onward 218. If the system finds the REFC 220, the system may display the corresponding FIG. 222 in the drawing window, highlight the desired REFC in that FIG. 224, and the system may return to waiting on a mouse click 210. If the forward search did not find the REFC, the system may search backward 226 from the current figure for the desired REFC. If the system finds the REFC 228, the system may display the corresponding FIG. 232 in the drawing window, highlight the desired REFC in that FIG. 234, and the system may return to waiting on a mouse click 210. If the REFC was not found also on the backward search, the system raises an error 230 to notify the user that the REFC in the specification may have no corresponding REFC in the drawings.

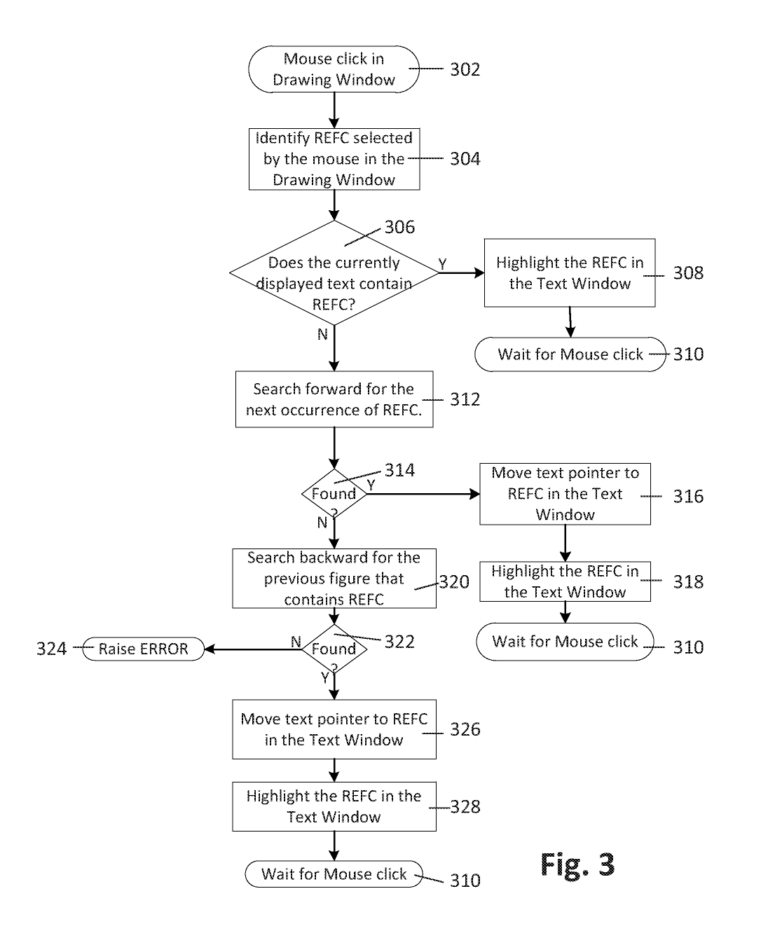

FIG. 3 is a drawing illustration of a flowchart illustrating a possible logic flow behind a reverse synchronization, where the text may be synchronized to the drawings. The system may wait on a mouse click in the drawing window in the proximity of an REFC. Once such mouse click arrives 302, the system may identify the closest REFC 304 to the click location in the displayed drawing by, for example, parsing the underlying graphics or through Optical Character Recognition (OCR) software. The system may then highlight the REFC, and may check 306 whether the currently visible text in the text window contains that REFC. If yes, the system may highlight this REFC in the text window 308 and may return to waiting on a mouse click 310. If the REFC does not exist in the currently visible text check 306, the system may search the text specification from the current point forward for the REFC 312. If the REFC is forward search found 314, the current text pointer of the specification may be moved to the REFC 316 with text window displaying its surrounding text, and the REFC may be highlighted 318. The system may return to waiting on a mouse click 310. If the REFC was not found on the forward search found 314, the system may search for the REFC backward from the current point 320. If backward search found 322, the current text pointer of the specification may be moved to the REFC 326 with text window displaying its surrounding text, and the REFC may be highlighted 328. The system may return to waiting on a mouse click 310. If the REFC was not backward search found 322, an error may be raised 324 to notify the user that the drawing REFC may have no corresponding REFC in the specification text.

Persons of ordinary skill in the art will appreciate that the illustrations in FIGS. 1 through 4 are exemplary only and are not drawn to scale. Such skilled persons will further appreciate that many variations are possible such as, for example, many additional utility and editing functions can be added to supplement the invention. For example, the ability to freely scroll the display in the text window and have the graphic window scroll synchronously based on the first REFC visible in the text window. Further, free-scrolling of the drawings in the graphic window can scroll synchronously the text window based on the drawing number in the graphic window. Another option may be the ability to easily point to a specialized text term and conveniently add it to a glossary section of the disclosure. Another option might be adding new REFCs into the drawings or the specifications files and the software assisting in correspondingly placing it in the other file and associating LT with them. Yet another might be the addition of rule checking of specification and drawings to verify adherence of the text or graphics to mandatory and optional rules of regulatory bodies, or offer text or graphical modifications to insure compliance with such. For example, verification of sequential numbering of drawings; another example could be verification that every REFC in the drawings is mentioned in the specification and vice versa. Many more similar verification features are commonly used by persons skilled in the art of rule-driven editors and they can make the described invention into a more functional capture and review system for technical disclosures. Many other modifications within the scope of the invention will suggest themselves to such skilled persons after reading this specification. Thus the invention is to be limited only by the appended claims.

While embodiments and applications of the present invention have been shown and described, it would be apparent to those of ordinary skill in the art that many more modifications than mentioned above are possible without departing from the inventive concepts herein. Further, the scope of the invention includes both combinations and sub-combinations of the various features described hereinabove. Thus the invention is to be limited only by the appended claims.

What is claimed is:

1. A computing system comprising: a processor, display, pointing device and memory;
wherein said memory comprises a text file, a graphics file corresponding to said text file and executable instructions to perform:
(i) identify a selection of an alphanumeric identifier within a displayed text file, and then
(ii) identify the appearance of said identifier in a corresponding graphics file, and then
(iii) display a page of said graphics file comprising said appearance of said identifier.

2. A computing system according to claim 1 wherein said text file comprises a patent specification file or a patent draft specification file and said graphics file comprises the drawings portion of said patent file or a patent draft file.

3. A computing system according to claim 1 wherein said memory comprises executable instructions to highlight said appearance of said identifier.

4. A computing system according to claim 1 wherein said system identification of the appearance of said identifier comprises the use of optical-character-recognition (OCR).

5. A computing system according to claim 1 wherein said selection of an identifier comprises executable instruction to highlight said identifier.

6. A computing system according to claim 1 further comprising the use of speech to text synthesis software, wherein said selection of an identifier comprises executable instructions to detect that said voice to text is processing said identifier.

7. A computing system according to claim 1 further comprising the use of speech-to-text voice recognition software to create at least portions of said text file.

8. A computing system comprising: a processor, display, pointing device and memory;
wherein said memory comprises a text file, a graphics file corresponding to said text file and executable instructions to perform:
(i) identify a selection of an identifier within a displayed graphics file, and then
(ii) identify appearance of said identifier in a corresponding text file, and then
(iii) display the page of said appearance of said identifier.

9. A computing system according to claim 8 wherein said text file comprises a patent specification file or a patent draft specification file and said graphics file comprises the drawings portion of said patent file or a patent draft file.

10. A computing system according to claim 8 wherein said memory comprises executable instructions to highlight said appearance of said identifier.

11. A computing system according to claim 8 wherein said system identifies a selection of an identifier comprising the use of optical-character-recognition (OCR).

12. A computing system according to claim 8 wherein said selection of an identifier comprises executable instructions to highlight said identifier.

13. A computing system according to claim 8 further comprising the use of speech to text synthesis software.

14. A computing system according to claim 8 further comprising the use of speech-to-text voice recognition software to create at least portions of said text file.

15. A computing system comprising: a processor, display, pointing device and memory;
wherein said memory comprises executable instructions to perform:
(i) identify a selection of a point within a displayed graphic file, and then
(ii) create an identifier to identify said point and then
(iii) add said identifier to said graphic file with a pointer pointing to said point.

16. A computing system according to claim 15 wherein said graphics file comprises the drawings portion of a patent file or a patent draft file.

17. A computing system according to claim 15 wherein said selection of a point comprises executable instructions to highlight said identifier.

18. A computing system according to claim 15 wherein said graphics file comprises a drawing number and said identifier comprises said drawing number.

19. A computing system according to claim 15, further comprising a related text file, and an executable instruction to add said identifier to said text file.

20. A computing system according to claim 15 wherein said create an identifier comprises creating a unique identifier.
